(19) United States
(12) Patent Application Publication
(10) Pub. No.: US 2008/0063850 A1
(43) Pub. Date: Mar. 13, 2008

(54) Composition and process for producing acrylic composite materials with mineral charges having superior mechanical, thermal and processing properties

(75) Inventors: Leopoldo Vilchis Ramirez, Ocoyoacac (MX); Manuel Roman Ahumada Romero, Ocoyoacac (MX); Jose Luis Pena Rosas, Ocoyoacac (MX); Maria de los Angeles de los Rios Corte, Ocoyoacac (MX)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: PLASTIGLAS DE MEXICO, S.A. DE C.V., Ocoyoacac (MX)

(21) Appl. No.: 11/851,870

(22) Filed: Sep. 7, 2007

(30) Foreign Application Priority Data
Sep. 8, 2006 (MX) PA/A/2006/010229

(51) Int. Cl. C08J 3/28; B32B 27/36; C08G 63/00

(52) U.S. Cl. 428/220; 522/182; 522/60; 522/65; 524/425; 524/430; 524/437; 524/579; 524/599

(57) ABSTRACT

A manufacturing process and composition of acrylic composite materials with mineral charges with high thermal, mechanical and processing properties is provided for manufacturing kitchen covering, washstands, sinks, shower bases, tables, bars, counters, and furniture in general. A prepolymer composition in addition to methyl methacrylate in equilibrium contains, comonomers and elastomers that provide optimized and specific properties to the final products, such as high impact strength, product transformability in order to allow superior drilling, screwing and bending actions, as well as higher thermoforming possibility. The resulting component is a polymer matrix surrounding discrete particles of the elastomer and the mineral component.

### CROSS-REFERENCE TO RELATED APPLICATION

This application claims the benefit of Mexican patent application PA/a/2006/010229, filed Sep. 8, 2006, which is hereby incorporated by reference in its entirety.

### FIELD OF INVENTION

The invention is directed to a process and composition for forming molded articles simulating stone, such as marble and granite. The invention is particularly directed to a process and composition containing mineral or inorganic particles and an elastomer.

### BACKGROUND OF INVENTION

At the present time, the requirements of mineral appearance materials for residential and commercial use, have increased in order to be used in the manufacturing of kitchen counters, washstands, sinks, shower bases, tables, bars, counters, table coverings, furniture and many other complex shapes. For these applications, frequently the person who processes or transforms the plastic, require that the materials adapt to specific shapes or curvatures. The traditional materials used for solid surfaces can be heated and bent to a maximum angle of 90°. After they are heated and curved over male molds under pressure or a vacuum suction canvas, cuts are made in the different curves in order to join together and glue the sections to obtain the final shape. The manufacturing process generates debris, and exhibits shrinkage from material cuts and breakage. Hence, the materials require high strength to avoid fractures when they are transformed for furniture, coverings or doors manufacturing, among other applications. The conventional materials described in the prior processes, do not have high tensile strength and generally exhibit a fragile performance. The tensile strength refers to the ability of the material to absorb a lot of energy before breaking or fracturing. Therefore, when the conventional materials are stressed, they may show internal cracks which result in fractures, while the tensile strength of the materials have the ability to absorb and dissipate energy, thereby avoiding fracturing of the material.

Products referred to as “solid surfaces” which are manufactured based on poly(methyl methacrylate) (PMMA) containing fine and microscopic particles of inert inorganic charges are known in the prior art. The “solid surface” products are produced by the process disclosed in U.S. Pat. No. 3,405,088 to Slocum, which describes the use at least 40% by weight mineral charges such as calcium carbonate, calcium sulfate, clay, silica and calcium silicate in poly(methyl methacrylate). U.S. Pat. Nos. 3,488,246 and 3,528,131 to Duggings describe the process and mixing equipment to manufacture these polymeric materials as calcium carbonate charged poly(methyl methacrylate).

U.S. Pat. No. 3,847,865 to Duggins discloses the use of trihydrated alumina (THA) as mineral charge for the manufacture of articles from poly(methyl methacrylate). This patent discloses the use of trihydrated alumina (ATH), preferably 55 to 80% by weight, as the mineral charge for the production of a acrylic structure with marble appearance and a combination of properties as translucidity, weathering resistance, flame resistance, breaking strength from stresses to increase the coefficient of thermal conductivity due the presence of the trihydrated alumina, higher crushing strength, as well as higher chemical resistance to the basic and acidic cleaners common in home use. These properties make the composite material suitable for use in kitchen counters. This patent describes the preparation of a prepolymer and its compositions, in which it is mentioned that the polymer also may be a copolymer contained in a higher amount than the methyl methacrylate with other monomer such as vinyl acetate, styrene, methyl acrylates, ethyl, butyl and cyclohexyl and ethyl, butyl and cyclohexyl methacrylates, also including various levels and kinds of additives. This composition is poured over a belt or mold and cured to obtain planar articles or any special shape with a pattern reassembling marble.

U.S. Pat. No. 4,183,991 to Smiley describes a process for the preparation of 0.1 to 4 inch thick acrylic foils or sheets with high levels of mineral charges, preferably trihydrated alumina from 40 to 80% by weight into a polymer solution. The composition of the solution is prepared based on a functional acrylic polymer in a monomer of an alkyl C₁₋₈ methacrylate, and one or more polymerizable compounds selected from styrene, alkyl styrenes, vinyl acetate, acrylonitrile, methacrylic acid or acrylic acid and 30% by weight of reinforcing fibers selected from group consisting of inorganic, cellulosic and organic synthetic fibers, in addition to 0.01 to 1% of polyethylenically unsaturated compounds selected from alkylene, dimethacrylates, trimethacrylates, diacrylates and triacrylates and divinyl benzene.

The foregoing patents only refer to obtaining of products with mineral appearance for planar or sheet applications. Notwithstanding, the compositions of “solid surfaces” using co-monomers, do not have sufficient impact strength, screwing and drilling ability, in addition to the thermoformability.

Another kind of synthetic solid surfaces are manufactured based on poly(methyl methacrylate) and alumina, which confer the appearance of artificial marble. These materials are described in WO 9520015 (1989), U.S. Pat. No. 5,286,290 (1994), WO9520015 (1995), and WO 0159006 (2001). The resulting products disclosed in these patents do not have sufficient high impact strength materials, and drilling, screwing and thermoforming properties.

U.S. Pat. No. 6,476,100 B2 of Beibei Diao (2002) discloses a process of obtaining materials of thermoformable solid surface, prepared by extrusion from acrylic compounds. The acrylic resin matrix is a compound based on poly(methyl methacrylate-glycidyl co-methacrylate), a disperse mineral charge preferably calcium carbonate and an epoxy acrylic copolymer functionalized by crosslinking with a linear or branched chain of an aliphatic carboxylic acid or an anhydride of the acid as the 1,12-dodecanedioic acid. The composition can be used to form a material by continuous-extrusion for obtaining sheets or laminas, which may be thermoformed under controlled temperature conditions and bent to obtain the desired shape. The obtained products show high thermal resistance and stain resistance. The process of the patent does not use elastomers. The materials do not have sufficient impact strength, screwing or drilling properties.

U.S. Pat. Nos. 6,562,927 B1 (2003), 6,177,499 (2001), 5,705,552 (1998), 5,567,745 (1996), and 5,521,243 (1996) to Minghetti, disclose an acrylic material with color distribution and homogeneous mineral charge before and after thermoforming. The patents describe the manufacturing method and the thermoformable lamina composition and articles made based on this lamina using different ranges of chain transfer agents, crosslinking agents, thixotropic agents and the content of mineral charge in order to attain an optimum balance and minimize the migration and poor color distribution of the mineral charge during the curing, and subsequent heating and deformation of the thermoforming process. In this way they attain to maintain the impact strength and enhance the stability of the patterns even in deformed parts formed from the laminas. Notwithstanding, the proposed solution by these patents disclose the butyl acrylate used as a co-monomer with the methyl methacrylate for the preparation of a prepolymer which is mixed with trihydrated alumina, in order to increase the impact strength. The chain transfer agents, tixotropic agents and crosslinking agents are added to obtain the thermoforming property. However, they do not attain sufficient impact strength, torque and screwing strength without fracture.

U.S. Pat. Nos. 6,773,643 (2004) and 6,462,103 (2002) to Beiteshees disclose a continuous method for the manufacturing of solid surfaces with tridimensional knobs having a wood appearance achieved by changing the partially mixed streams of acrylic resin compositions, with defined parameters of viscosity, density and surface tension. These patents disclose the use of impact modifiers as the elastomeric polymers such as methyl methacrylate, styrene and butadiene grafted copolymers (MBS), butyl acrylate and methyl methacrylate copolymers, and other modifiers known to increase the impact strength. These patents do not disclose the point the components are added, the concentrations, the effect that the modifiers provide to the polymeric matrix, or the kind of applications, uses and advantages.

### SUMMARY OF THE INVENTION

This invention is directed to a process and composition of polymerized acrylic composite materials with about 5 to 80% by weight mineral charge content. The invention is also directed to a polymerizable composition containing about 20 wt % of a prepolymer containing a polymerizable acrylate component, about 5 to 80 wt % of a particulate mineral and about 0.1 to 10 wt % of a polymeric elastomer. The invention is further directed to materials having a high thermo-mechanical property.

This composite materials are manufactured from a prepolymer which in addition to a methyl methacrylate monomer contains one or several co-monomers and one or several elastomers in an amount to provide specific and optimized physical, mechanical and processing properties to the final products. This prepolymer is mixed and polymerized in presence of mineral charges, such as calcium carbonate, silica, glass or mica spheres, and alumina, to obtain acrylic composite materials with properties and appearance of inorganic materials. In one embodiment, the mineral component is primarily trihydrated alumina (THA). In addition to the mineral charge, the materials may contain granular polymeric pigments and/or charges to imitate natural stones such as granite, onyx or marble.

The acrylic composite materials are manufactured by a molding process, providing the ability to obtain different sizes, thicknesses, and shapes. The acrylic composite materials obtained by the present invention show high impact strength, high tensile, and suitable processability of the product, thereby providing the ability to be drilled or screwed in order to manufacture complex shapes without failures. When the materials are in lamina or plate form, they may be heated and transformed into a single piece, by vacuum or pressure mold thermoforming process while retaining the physical and mechanical properties.

One of the novel aspects of the present invention, is directed to producing composite acrylic materials having easy transformation processability, high tensile strength and the ability to be transformed by the standard lamina heating and forming processes. The composites of the invention can be formed over concave or convex molds, and cooled to obtain the desired shape.

The process and the prepolymer preparation manner in which the mineral charge is mixed, provide these additional properties. Furthermore, the tensile strength of the material, provides the ability to be drilled or screwed without chipping or fracture. These properties are not exhibited by the conventional materials or solid surfaces.

The acrylic composite materials obtained by the process of this invention, may be generally used for manufacturing doors, furniture, and coverings, in which the person who transforms them requires the material to have a high strength. The present materials may be drilled and screwed or fixed by bolts, while conventional materials only may be glued for assembly for coatings over wood parts.

The material of the present process may be used in circumstances in which the material is subject to torsion stress by drilling with different bit thicknesses, and will withstand tensile strengths from screws in order to secure the hinge plates for constant movement pieces, as is in the case of doors. In the material of the present invention, the advantages are achieved due to the strength by the energy absorption and dissipation that the elastomer confers to the multi-component material (polymer-mineral) avoiding the fracture that the conventional material shows when it is subject to stresses.

### BRIEF DESCRIPTION OF THE DRAWINGS

The following is a brief description of the drawings, in which:

FIG. 1 is a magnified image of the molded composition in one embodiment of the invention; and

FIGS. 2A and 2B are magnified images of the molded composition of the image.

### DETAILED DESCRIPTION OF THE INVENTION

In accordance with the present invention, the process to obtain acrylic composite materials with mineral charges with superior mechanical, thermal and processing properties includes 4 steps. Step 1, prepolymer or resin preparation, step 2, material mixing, step 3, mold filling and polymerization or curing, and step 4, thermal treatment or post-curing.

The first step for the prepolymer or resin preparation is carried out in a reservoir provided with a constant agitation system wherein the selected monomers and elastomers are added. The amount ratio of them monomer is from 0 to about 50 parts of an ethylenically unsaturated monomer, preferably styrene, and from about 100 to 50 parts of an alkyl acrylate or alkyl methacrylate, preferably methyl methacrylate. The elastomer is included in amount of about 0.1 to 10 parts by weight, where the elastomer is a polymer obtained from a diene monomer. The elastomer is dissolved and integrated in the monomer mixture. The elastomeric polymer from a diene monomer is selected from the group consisting of polybutadiene (PB) of types high cis and medium cis, and/or butadiene copolymers with random structure such as acrylonitrile-butadiene-styrene (ABS), copolymer with block structure as styrene-butadiene-styrene-(SBS) or styrene-butadiene (SB) or functionalized polybutadiene or mixtures of two or more of them.

In this disclosure, the parts are interpreted as parts by weight based on the weight of the composition. In one embodiment of the invention, the polymerizable composition includes about 20 wt % to 80 wt % of the prepolymer and about 20 wt % to 80 wt % of the inorganic particulate filler or mineral based on the total weight of the polymerizable composition.

The prepolymer includes an alkyl (meth)acrylate monomer and a polymeric elastomer. In one embodiment, the prepolymer includes about 0.1 wt % to about 20 wt % of the polymeric elastomer and typically about 0.1 wt % to about 10 wt % of the polymeric elastomer based on the total weight of the prepolymer. The prepolymer is prepared by mixing the monomer component to disperse the polymeric elastomer into the monomer component and polymerizing to obtain a conversion of about 1% to 30%. The polymeric elastomer typically has a particle size of about 0.1 micron to 50 microns in the resulting prepolymer and the polymer phase of the resulting composite matrix. The mineral component is dispersed in the prepolymer and the resulting mixture is polymerized to form a composite of a polymer matrix. The polymer matrix is a substantially continuous phase containing the polymeric elastomer particle and the mineral component dispersed therein. The particle size of the mineral component can vary depending on the desired appearance.

In one embodiment of the invention, the prepolymer includes a second ethylenically unsaturated monomer component in addition to the alkyl (meth)acrylate monomer. The ethylenically unsaturated monomer is typically styrene, although other monomers can be used such as (meth)acrylic acid and esters thereof such as butyl acrylate, methyl acrylate and ethyl acrylate. The ethylenically unsaturated monomer can be included in an amount of about 1 wt % to about 50 wt % based on the total weight of the prepolymer. Typically, the ethylenically unsaturated monomer is included in an amount of about 5 wt % to 25 wt % based on the total weight of the prepolymer. In one embodiment, the second ethylenically unsaturated monomer is included in an amount of up to 50 parts by weight based on 100 parts by weight of the prepolymer.

In this step, an ultraviolet light stabilizer agent is added in amounts of about 0.05 to 0.5 parts by weight, which include stabilizer HALS type (Hindered Amine Light Stabilizers) containing an hindered amine and stabilizer derived from benzotriazole. The HALS type ultraviolet light stabilizer agents are selected from group consisting of bis-(1-octyloxy-2,2,6,6,tetramethyl-4-piperidinyl)sebacate; dimethyl succinate polymer with 4-hydroxy-2,2,6,6, tetramethyl-1-piperidine ethanol; bis(2,2,6,6,-tetramethyl-4-piperidinyl)sebacate; 1,3,5-triazine-2,4,6-triamino, N,N″-[1,2-ethanodiylbis[[[4,6-bis[butyl(1,2,2,6,6-pentamethyl-4-piperidinyl)amino]-1,3,5-triazine-2-yl]imino]-3,1propanediyl]]-bis[N,N″-dibutyl-N,N″-bis(1,2,2,6,6-pentamethyl-4-piperidinyl)-; poly-[[6-[(1,3,3,-tetramethyl butyl)amino]-s-triazine-2,4-diyl][[(2,2,6,6-tetramethyl-4-piperidyl)imino]hexamethylene[(2,2,6,6-tetramethyl-4-piperidyl)imino]]; or mixtures of the same. While ultraviolet light stabilizer agents derived from benzotriazole are selected from group consisting of 2-(2′-hydroxy-5-methyl-phenyl)benzotriazole; 2-(2H-benzotriazole-2-ii)-4,6-bis(1-methyl-1-phenylethyl)phenol; 2-(5-chloro-2H-benzotriazole-2-yl)6-(1,1-dimethylethyl)-4-methylphenol; 2-(3′,5′-di-tert-butyl-2-hydroxyphenyl)-5-chlorobenzotriazole; 2-(2H-benzotriazole-2-yl)-4,6-bis(1,1-dimethylpropyl)phenol, and mixtures thereof. Preferably, the ultraviolet light stabilizer agents mixture is formed with 2-(2hydroxy-5-methyl-phenyl)benzotriazole and bis-(2,2,6,6-tetramethyl-4-piperidinyl)sebacate. The monomer mixture is mixed or shaken until a single phase is formed and the components are dispersed or dissolved.

The homogeneous dissolution or solution of the monomer, elastomer and other component is introduced into an atmospheric pressure reactor to carry out the prepolymerization reaction. The solution is heated from about 20° C. to 90° C. interval in order to proceed with the reaction. A peroxide type or azo type initiator agent selected from the group consisting of terbutyl peroxypivalate, terbutyl peroxyneodecanoate, azo-bis-iso buthyronitrile, 2,2′-azobis(2,4-dimethylpentanonitrile), bi(4-terbutylcyclohexyl)peroxydicarbonate or tert-butyl monoperoxymaleate is added in amounts of about 0.01 to 1 parts by weight with respect to the monomer mixture. In addition to the initiator, a chain transfer agent is incorporated into the mixture in amounts of about 0.01 to 0.1 parts by weight with respect to the monomer mixture. The transfer agent is a mercaptan selected from the group consisting of n-dodecyl mercaptan, n-octyl mercaptan and n-butyl mercaptan group.

After all the additives are incorporated into the mixture, the polymerization reaction is maintained until a conversion from 1 to 30% of the prepolymer is attained to produce the prepolymer containing the elastomeric particles with a particle size diameter of about 0.1 to 50 microns dispersed in the prepolymer. Once the object conversion is obtained, preferably between 10 and 20%, the prepolymer is cooled and stored in a reservoir, to complete the prepolymer or resin preparation step to obtain a polymer in monomer mean molecular weight of 1,000,000 Daltons and 2 to 3 polydispersivities.

In the step 2 corresponding to the material mixture step, the prepolymer from step 1 is mixed in amounts from about 20 up to 95 parts by weight, in a specially designed mechanical agitation and vacuum pressure reservoir, with the mineral charge. The mineral charge is selected from group consisting of calcium carbonate, silica, glass or mica spheres and alumina, and preferably trihydrated alumina (ATH). The mineral and other particulate fillers have a particle size of about 5 to 50 microns, and typically about 15 to 25 microns. The mineral charge is added in an amount of between 5 to 80 parts by weight, depending on the required final properties. In this embodiment, the parts by weight of the prepolymer and the mineral are based on 100 parts by weight of the polymerizable composition. The resulting composition can contain about 20 to 95 wt % of the prepolymer and about 5 to 80 wt % of the mineral or other particulate fillers based on the total weight of the composition. The mineral charge is slowly incorporated to the prepolymer mixture with agitation to avoid aggregation. The agitation is carried out by an anchor type propeller at a speed of 100 to 300 revolutions per minute (RPM) for 30 to 60 minutes at room temperature. In this operation the charge humectation process is carry out by the addition of surface tension modifiers, and rheologic behavior or reaction mixture viscosity modifiers.

In order to obtain a suitable charge incorporation and dispersion, a dispersing agent is added in an amount of about 0.01 to 2 parts by weight with respect to the mixture. Preferably, the dispersing agent is selected from group consisting of an ester solution of a hydroxyfunctional carboxylic acid, an ester from a hydroxyfunctional carboxylic acid, copolymer with acid groups, an amide solution from a polyhydroxycarboxylic acid, a salt solution from unsaturated polyamineamides and a low molecular weight acidic polyester, a salt solution from a polycarboxylic acid from polyamides, a polymer solution from a low molecular weight unsaturated polycarboxylic acid, a polar acid ester from long chain alcohols, and others. In order to eliminate the bubbles produced by agitation, deaerating agents are added in an amount of 0.1 to 1 parts by weight. The deaerating agents can be polymer of dissolution type and foam destroyer polysiloxanes, polymeric anti-foaming agents without silicone, polyacrylate dissolution and foam destroyer polymers, without silicone, and others. Finally, in order to control the viscosity of the final mixture, modified urea dissolution type additives, are added in amounts of about 0.01 to 2 parts by weight.

After the dispersion is accomplished, the additives are added, in this case as a mold release agent, a sodium dioctylsulfosuccinate type surfactant and an anionic type unneutralized phosphated alcohol solution in amounts of 0.003 to 1 parts by weight with respect to the mixture. A thermal stabilizer can be added in amounts of 0.01 to 1 parts by weight. Examples of the stabilizer include an organophosphite type selected from the group consisting of di-phenyl isodecyl phosphite, triisodecyl phosphite or any other compound from formula P0₃-R₁R₂R₃, wherein R₁R₂R₃ are hydrocarbon substituents with 2 to 30 carbon atoms. Furthermore a crosslinking agent is added, selected from the group consisting of ethylene glycol dimethacrylate, diethyleneglycol dimethacrylate, triethyleneglycol dimethacrylate, tetraethyleneglycol dimethacrylate, tetradecapropyleneglycol dimethacrylate, neopentyl glycol diacrylate, in amounts of 0.001 to 2.0 parts by weight with respect to the mixture.

In addition to the additives in this phase the pigments and the granites are incorporated to provide the final finish of the product. Granite is a material made based on alumina, titanium dioxide and mainly from polyester grains, acrylic or crushed minerals in a variety of sizes, shapes and colors, which when added jointly with the trihydrated alumina gives a structure that appears to be rock, granite of natural marble. The granites by nature maintain their size and are homogenously dispersed into the prepolymer/mineral charge mixture. As used herein, the term “granite” refers to a particulate filler which can be added to provide the desired appearance. The particulate filler can be a natural or synthetic inorganic particle or polymer particles.

Finally, the peroxide type or azo type initiating agent is added, selected from group consisting of terbutyl peroxypivalate, terbutyl peroxyneodecanoate, azo-bis-iso butyronitrile, 2,2′-azobis(2,4-dimethylpentanonitrile, bis(4-terbutylcyclohexyl)peroxydicarbonate or tert-butyl monoperoxymaleate, in amounts of 0.001 to 3 parts by weight with respect to prepolymer. The initiating agent will serve to achieve the total monomer polymerization from mixture in presence of alumina.

At the same time the dispersion is carried out, the mixture is subject to a negative pressure in vacuo so as to eliminate the trapped air that may cause bubbles or pores within the final material. The in vacuo process is carried out under pressure between 30 and 60 cm Hg, with continuous agitation for 15 and 60 minutes, to provide enough time to eliminate the trapped air. This step along with the prepolymerization step control the final properties of the finished product according to the invention.

Once the material mixing action is finished, step 3 corresponding to the closed or opened molds filling is carried out. Preferably, the mold product is perfectly polished and free of imperfections so as to pass into the curing or polymerization process. The curing process is carried out from room temperature up to 80° C., depending on the concentration and type of the selected curing initiator. Again this step will have an important effect on the final properties of the product of this invention. In order to control the mixture temperature within the mold, water circulation vats or air circulation or infrared heating source ovens are used. The heating action allows the polymerization initiation to reach a monomer conversion of 95% in a lapse of 3 to 5 hours, depending on the plate or piece thickness, concentration and type of curing initiating agent.

In step 4, the mold with the product inside is subject to thermal treatment or post-curing at a temperature of 90° C. to 130° C. in order to attain the total monomer conversion (˜100%), during a period of 1 to 5 hours using a heating means, such as water vats, air convection or infrared radiation ovens. The mold containing the material must be cooled so that the final product may be separated from the mold.

One of the novel aspects of the present invention is the inclusion of elastomers obtained from a diene monomer added in the prepolymer synthesis. The elastomers are grafted on the polymer produced during prepolymerization reaction, to form elastomeric particles in the reaction medium having particle morphologies with “salami” type occlusions, and/or layered morphologies or core-shell type. The resulting resin is mixed with the ATH micro-particles to provide high tensile strength and impact resistance, torque strength and screwed strength. The achieved morphology provide the material with the thermoforming and malleability properties.

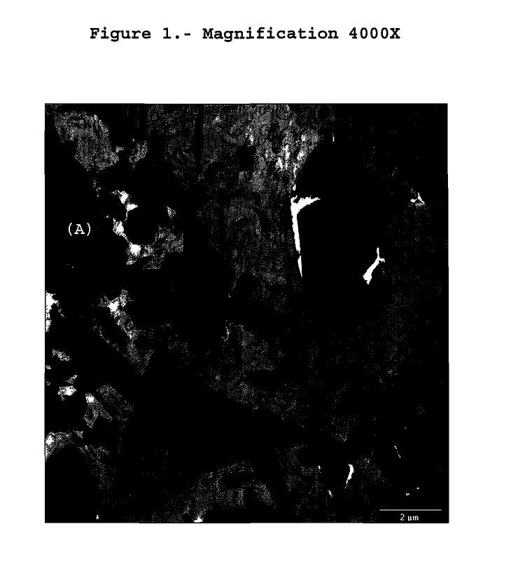

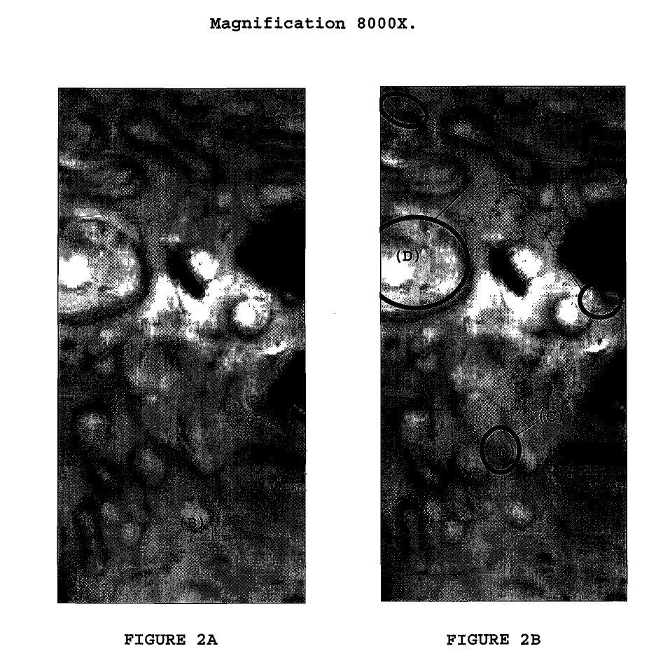

FIG. 1 shows an image of a material made in accordance with the present invention, where the image obtained by transition electronic microscopy and a staining with osmio tretroxide in order to achieve an adequate component contrast. This image shows that the material has a multi-phase structure. In a total obscure contrast, the inorganic charge, identified by the letter (A) which in this case corresponds to alumina, and the clear tone is the phase associated to synthesized polymer identified by the letter (B). Referring to FIGS. 2A and 2B, the letter (C) identifies the elastomer grouped as dispersed particles in the polymeric phase, and appears as an obscure tone within the polymeric phase (B). FIG. 1 also shows that the alumina particles (A) are encircled by the polymeric phase (B), showing a perfect coupling between the particles and the polymeric matrix.

FIGS. 2A and 2B show a larger enhanced image of the polymeric phase, and more clearly show the elastomer (C) segregated in cellular particles formed as a layered or core-shell structure. The continuous phase of the synthesized polymer (B) encircles the elastomer particles (C). The interior of the elastomeric particles has a synthesized polymer core or occlusion (D) and an elastomeric layer (C). This sequence may be repeated two or three times in the same particle.

The product obtained by the process described in this invention, is a mineral charge composite material with properties differentiated from the conventional materials. This material exhibits a high tensile strength and impact strength according to Gardner (ASTM D-3029) of 56 to more than 320 lb/inch, at thicknesses of 12 mm, and has the ability to withstand heating temperatures up to 200° C. without color change or yellowing from thermal degradation. The resulting product possesses enhanced processing properties by having the ability to be thermoformed into a single piece by heating of the lamina up to about 200° C., and afterwards forming in vacuo, pressing or by elastic membranes action with vacuum and thereafter cooling to obtain the desired shape. The composition can be used to produce washstands, sinks, shower bases, and generally furniture.

The resulting composite materials have the ability to be screwed, drilled to depths of 1-2 mm from the lamina edge, and exhibit high cut resistance without material fracture. In this way, the material can withstand torsion stress by different bit thicknesses, and afterwards may be subject to tensile strengths from screws in order to secure the hinge plates of doors, hatchways, tables, etc. which will be in constant movement without chipping or expanding.

The following examples describe the typical formulations evidencing the present invention but without limitation. Because of the described materials in the examples are evaluated by thermoforming and breaking strength by screwing performance or processability, the test methods are described in the following examples.

Thermoforming Method

The thermoforming evaluation method consists of heating the plate in a heated air circulation oven to attain a plate uniform temperature of 200° C. The required time for the plate softening may be transformed into stilts that require stretching, is of 9.5 minutes for plates with a thickness of 3 mm and 18 minutes for plates having a thickness of 6 mm. Once the objective temperature is achieved, the material is placed over a planar base connected to a compressed air flow to form the material by pressure. The plate is then held by a support with a circle in the center with a 45 cm diameter. Pressure by compressed air is injected, manually regulated to attain a central height of 25 cm so as to simulate a washstand shape. Once the center height is achieved, the air flow is maintained until the material reaches the room temperature. The result of this method is reported as “Thermoform” if the material withstands the forming action and reaches the height of 25 cm or shows fracture, breaking or color or design change.

Breaking Strength by Screwing Method

The breaking strength by the screwing evaluation method consists of carry out the penetration of helical worm screw of ⅛ or 1/7 inches, previous drilling holes with tungsten carbide bits. The drill bits are diamond tip or quick speed steels of 1/12 inch diameter. The method consists of drilling pieces of material in angle of 90 degrees with separating distance of 2 mm from both edges, proceeding to bit drilling with an solid angle of 70 to 120 degrees and cutting edge rake angle of 10 to 25 degrees, by a conventional drill speed of 2000 revolutions per minute. After drilling, the material is subject to constant stress by the helical worn screw penetration. The result of this test method is reported “Without Fracture” if the material withstands the screw penetration after drilling, or else it is reported as “Fracture” if the material shows fracture or chipping off.

### EXAMPLE 1

The present example was carried out to compare a conventional material with the present invention, showing the mechanical properties of impact strength and functionality thereof.

Within an atmospheric reactor, provided with a navy type pneumatic propeller agitator operated at 300 RPM agitation speed, 100 parts of methyl methacrylate monomer, 0.02 parts of n-dodecyl mercaptan (NDDM) as chain transfer agent, 0.03 parts of 2-(2′hydroxyphenyl)-benzotriazole), as well as 0.02 parts of terbutyl peroxyneodecanoate as initiators were introduced where the amounts are parts by weight. The reaction mixture is carried out at a temperature of 82° C., maintaining constant agitation until a conversion of 12% obtained and the reaction product has a mean molecular weight of 190,000 Daltons and a polydispersivity of 2.2. At this point, the reaction mixture is cooled to room temperature, and is referred to as prepolymer.

This prepolymer is filtered through a 200 microns mesh, within a reservoir for mixing and provided with vacuum and agitation at 100 RPM with an anchor type propeller. Afterward, 70 parts by weight of trihydrated alumina having a 20 micron particle size, 0.1 parts of ethylene glycol dimethacrylate, 0.2 parts of sodium dioctyl sulfosuccinate, 0.3 parts of diphenyl isodecyl phosphite and 0.02 parts of 2,2′-azobis(2,4-dimethylpentanonitrile) as an initiator are added.

The mixture is then subject to 50 cm Hg in vacuo pressure, maintaining the agitation at 100 RPM, for 30 minutes. Once the mixing, dispersion and vacuum step is finished, the mixture is introduced into 3 molds to obtain planar plates of 2.40×1.80 meters size and thicknesses of 12 mm, 6 mm and 3 mm, respectively. The mold is sealed and introduced in a 58° C. hot water vat for 5 hours, wherein the mixture attains a 95% conversion. A 99% conversion is obtained by raising the temperature of the water to 90° C. and maintaining the molds at this temperature for 2 more hours. After this thermal treatment process, the mold is cooled to room temperature and the plate or plaque is separated from the mold.

The resulting plates were subjected to tests for the determination of mechanical properties, for flexing (ASTM D-790), impact strength Gardner (ASTM D-5420), impact strength Izod (ASTM D-256), impact strength Dynatup (ASTM D-3763) and thermoforming functionality and screwing tests in accordance with the test methods previously described which results are reported in Tables 1, 2, 3 and 4.

### EXAMPLE 2

Within an atmospheric reservoir with 1200 RPM agitation and navy type propeller, 20 parts of styrene monomer, 80 parts of methyl methacrylate monomer and 6 parts of polybutadiene high-cis were incorporated, and 0.1 parts of 2-(2′hydroxy-5methyl-phenyl)-benzotriazole) and 0.1 parts of bis-(2,2,6,6-tetramethyl-4-piperidinyl)sebacate were added. The amounts are parts by weight. The mixture was agitated for 3 hours at room temperature until the total amount of the butadiene polymer was dissolved or dispersed in the monomers.

The resulting mixture is filtered and transfer to an atmospheric reactor with 300 RPM agitation, where 0.03 parts of terbutyl peroxypivalate was added as an initiator. The reaction mixture is carried out at a temperature of 82° C., while maintaining constant agitation to reach 8% conversion with a mean molecular weight of 160,000 Daltons and a polydispersivity of 2.5. Finally, the resulting prepolymer is cooled to room temperature.

This prepolymer is filtered through a 200 micron mesh, within a reservoir for mixing provided with vacuum and agitation at 100 RPM with an anchor type propeller. 70 parts by weight of trihydrated alumina having a 20 micron particle size, 1.05 parts of ethylene glycol dimethacrylate, 0.05 parts of sodium dioctyl sulfosuccinate, 0.15 parts of a diphenyl isodecyl phosphite, 1.5 parts of a dispersing agent, polar acidic ester type from long chain alcohols, 0.5 parts of deaerating agent from polymeric anti-foaming type without silicone, 0.5 parts of a dissolution type viscosity control agent from modified urea and 0.05 parts of terbutyl peroxypivalate as an initiator are added. With the prepolymer thus formulated, the prepolymer is mixed and molded to form plates of 12 mm thickness with 2.40×1.80 meters size, according to the same mold thermal procedure described in Example 1.

The resulting plate was subjected to tests for the determination of impact strength Gardner (ASTM D-5420), and screwing functionality in accordance with the test methods previously described which results are reported in Tables 1 and 3.

### EXAMPLE 3

To an atmospheric reservoir with 1200 RPM agitation and navy type propeller are added 20 parts of styrene monomer, 80 parts of methyl methacrylate monomer and 8 parts of polybutadiene where the amounts are parts by weight. 0.1 parts of 2-(2′hydroxy-5methyl-phenyl)-benzotriazole) and 0.3 parts of bis-(2,2,6,6-tetramethyl-4-piperidinyl)sebacate were then added. The mixture was agitated for 6 hours at room temperature to obtain the total dissolution of the butadiene polymer in the monomers.

The resulting mixture is filtered and transferred to an atmospheric reactor with 300 RPM agitation, and 0.03 parts of terbutyl peroxypivalate as initiator are added. The reaction mixture is carried out at a temperature of 82° C., while maintaining constant agitation until to reach 8% conversion. Finally, the prepolymer is cooled to room temperature, with a mean molecular weight of 160,000 Daltons and a polydispersivity of 2.5.

This prepolymer is filtered through a 200 micron mesh, within a reservoir for mixing provided with vacuum and agitation at 100 RPM with anchor type propeller, 70 parts by weight of trihydrated alumina, 1.05 parts of ethylene glycol dimethacrylate, 0.05 parts of sodium dioctyl sulfosuccinate, 0.15 parts of diphenyl isodecyl phosphite, 1.5 parts of dispersing agent, polar acidic ester type from long chain alcohols, 0.5 of deaerator agent from polymeric anti-foaming type without silicone, 0.5 of dissolution type viscosity control agent from modified urea and 0.05 parts of terbutyl peroxypivalate as initiator are added. The prepolymer thus formulated is formed into a plate of 12 mm thickness, with 2.40×1.80 meters size by the same procedure described in Example 1.

The resulting plate was subjected to tests for the determination of impact strength Gardner (ASTM D-5420), and screwing functionality in accordance with the test methods previously described which results are reported in Tables 1 and 3.

### EXAMPLE 4

To an atmospheric reservoir with 1200 RPM agitation and navy type propeller, 15 parts of styrene monomer, 85 parts of methyl methacrylate monomer and 4 parts of polybutadiene, as well as 0.1 parts of 2-(2′hydroxy-5methyl-phenyl)-benzotriazole) and 0.3 parts of bis-(2,2,6,6-tetramethyl-4-piperidinyl)sebacate were added. The mixture was agitated for 6 hours at room temperature to obtain the total dissolution of the butadiene polymer in the monomers.

The resulting mixture is filtered and transfer to an atmospheric reactor with 300 RPM agitation, and 0.03 parts of terbutyl peroxypivalate as initiator are added. The reaction mixture is carried out at a temperature of 82° C., while maintaining constant agitation until to reach 8% conversion. Finally, the prepolymer is cooled to room temperature, with a mean molecular weight of 170,000 Daltons and a polydispersivity of 2.4.

This prepolymer is filtered through a 200 micron mesh, within a reservoir for mixing provided with vacuum and agitation at 100 RPM with anchor type propeller. 70 parts by weight of trihydrated alumina, 1.05 parts of ethylene glycol dimethacrylate, 0.05 parts of sodium dioctyl sulfosuccinate, 0.15 parts of diphenyl isodecyl phosphite, 1.5 parts of dispersing agent, polar acidic ester type from long chain alcohols, 0.5 of deaerator agent from polymeric anti-foaming type without silicone, 0.5 of dissolution type viscosity control agent from modified urea and 0.05 parts of terbutyl peroxypivalate as initiator are added. The prepolymer thus formulated is formed into plates of 6 mm and 3 mm thickness with 2.40×1.80 meters size by the same procedure described in Example 1.

The resulting plates were subjected to tests for the determination of mechanical properties, for flexing (ASTM D-790), impact strength Gardner (ASTM D-5420), impact strength Izod (ASTM D-256), impact strength Dynatup (ASTM D-3763) and thermoforming functionality and screwing tests in accordance with the test methods previously described which results are reported in Tables 1, 2, 3 and 4.

### EXAMPLE 5

The same prepolymer obtained under the procedure described in Example 1 is filtered through a 200 micron mesh, within a reservoir for mixing provided with vacuum and agitation at 100 RPM with anchor type propeller. 22 parts by weight of trihydrated alumina, and 18 parts of grey color polyester granules, 1.5 parts of ethylene glycol dimethacrylate, 0.15 parts of sodium dioctyl sulfosuccinate, 0.15 parts of diphenyl isodecyl phosphite, 1.5 parts of dispersing agent, polar acidic ester type from long chain alcohols, 0.5 of deaerator agent from polymeric anti-foaming type without silicone, 0.5 of dissolution type viscosity control agent from modified urea and 0.05 parts of terbutyl peroxypivalate as initiator are added. The prepolymer thus formulated is formed into plates of 3 and 6 mm thickness with 2.40×1.80 meters size by the same procedure described in Example 1.

The resulting plates were subjected to tests for the determination of mechanical properties, for flexing (ASTM D-790), impact strength Gardner (ASTM D-5420), impact strength Izod (ASTM D-256), impact strength Dynatup (ASTM D-3763) and thermoforming functionality and screwing tests in accordance with the test methods previously described which results are reported in Tables 1, 2, 3 and 4.

### EXAMPLE 6

To an atmospheric reservoir with 1200 RPM agitation and navy type propeller, 100 parts of methyl methacrylate monomer and 6 parts of polybutadiene, as well as 0.1 parts of 2-(2′hydroxy-5methyl-phenyl)-benzotriazole) and 0.3 parts of bis-(2,2,6,6-tetramethyl-4-piperidinyl)sebacate were added. The mixture was agitated for 6 hours at room temperature to obtain the total dissolution of the butadiene polymer in the monomers.

The resulting mixture was filtered and transferred to an atmospheric reactor with 300 RPM agitation, while adding 0.03 parts of terbutyl peroxypivalate as an initiator. The reaction mixture is carried out at a temperature of 82° C., while maintaining constant agitation to reach 8% conversion. Finally, the prepolymer is cooled to room temperature, with a mean molecular weight of 190,000 Daltons and 2.2 of polydispersivity.

This prepolymer is filtered through a 200 micron mesh, within a reservoir for mixing provided with vacuum and agitation at 100 RPM with anchor type propeller. 22 parts by weight of trihydrated alumina and 18 parts by weight of grey granite, 1.05 parts of ethylene glycol dimethacrylate, 0.05 parts of sodium dioctyl sulfosuccinate, 0.15 parts of diphenyl isodecyl phosphite, 1.5 parts of dispersing agent, polar acidic ester type from long chain alcohols, 0.5 of deaerating agent from polymeric anti-foaming type without silicone, 0.5 of dissolution type viscosity control agent from modified urea and 0.05 parts of terbutyl peroxypivalate as initiator are added. The prepolymer thus formulated is formed into plates of 3 mm and 6 mm thickness with 2.40×1.80 meters size by the same procedure described in Example 1.

The resulting plates were subjected to tests for the determination of mechanical properties, for flexing (ASTM D-790), impact strength Gardner (ASTM D-5420), impact strength Izod (ASTM D-256), impact strength Dynatup (ASTM D-3763) and thermoforming functionality and screwing tests in accordance with the test methods previously described which results are reported in Tables 1, 2, 3 and 4.

### EXAMPLE 7

To an atmospheric reservoir with 1200 RPM agitation and navy type propeller, 10 parts of styrene monomer and 90 parts of methyl methacrylate monomer and 3 parts of polybutadiene, as well as 0.1 parts of 2-(2′hydroxy-5methyl-phenyl)-benzotriazole) and 0.3 parts of bis-(2,2,6,6-tetramethyl-4-piperidinyl)sebacate were added. The mixture was agitated for 6 hours at room temperature to obtain the total dissolution of the butadiene polymer in the monomers.

The resulting mixture is filtered and transferred to an atmospheric reactor with 300 RPM agitation, while adding 0.03 parts of terbutyl peroxypivalate as an initiator. The reaction mixture is carried out at a temperature of 82° C., while maintaining constant agitation to reach 8% conversion. Finally, the prepolymer is cooled to room temperature, with a mean molecular weight of 139,000 Daltons and polydispersivity of 2.6.

This prepolymer is filtered through a 200 micron mesh, within a reservoir for mixing provided with vacuum and agitation at 100 RPM with anchor type propeller. 22 parts by weight of trihydrated alumina and 18 parts by weight of grey granite, 1.05 parts of ethylene glycol dimethacrylate, 0.05 parts of sodium dioctyl sulfosuccinate, 0.15 parts of diphenyl isodecyl phosphite, 1.5 parts of dispersing agent, polar acidic ester type from long chain alcohols, 0.5 of deaerating agent from polymeric anti-foaming type without silicone, 0.5 of dissolution type viscosity control agent from modified urea and 0.05 parts of terbutyl peroxypivalate as initiator are added. The prepolymer thus formulated is formed into plates of 3 mm and 6 mm thickness with 2.40×1.80 meters size by the same procedure described in Example 1.

The resulting plates were subject to tests for the determination of mechanical properties, for flexing (ASTM D-790), impact strength Gardner (ASTM D-5420), impact strength Izod (ASTM D-256), high speed impact strength using load and sliding sensors (Dynatup Impact-ASTM D-3763) and thermoforming functionality and screwing tests in accordance with the test methods previously described which results are reported in Tables 1, 2, 3 and 4.

TABLE 1
Impact Strength Results

| | | | | | | Gardner | | | |
|---|---|---|---|---|---|---|---|---|---|
| | | | | | | Impact | | (Dynatp | Izod |
| | | | | | | (N · | | Impact) | Impact |
| Example | Alumina | Granite | Elastomer | Styrene | Thickness | m)⁽¹⁾ | Thickness | (J/mm)⁽²⁾ | (N · m/m) |
| 1 | 70% | 0% | 0 | 0 | 12 mm | 8.13 | 12 mm | | |
| 2 | 70% | 0% | 6% | 20% | 12 mm | 30.73 | 12 mm | — | — |
| 3 | 70% | 0% | 8% | 20% | 12 mm | >36.16 | 12 mm | — | — |
| 1 | 70% | 0% | 0 | 0 | 6 mm | 6.33 | 3 mm | 17.98 | 11.16 |
| 4 | 70% | 0% | 4% | 15% | 6 mm | 18.98 | 3 mm | 27.74 | 20.85 |
| 5 | 22% | 18% | 0% | 0% | 6 mm | 10.39 | 3 mm | 18.08 | 10.86 |
| 6 | 22% | 18% | 6% | 0% | 6 mm | 20.79 | 3 mm | 62.79 | 33.90 |
| 7 | 22% | 18% | 3% | 10% | 6 mm | 19.89 | 3 mm | 39.21 | 25.29 |

⁽¹⁾Break Gardner Impact is reported.
⁽²⁾Total Energy normalized to sample thickness is reported.

TABLE 2
Thermomechanical properties results

| | | | Vicat | |
|---|---|---|---|---|
| Example | Thickness | HDT (° C.) | (° C.) | Thermoforming |
| 1 | 6 mm | 99.0 | 105.7 | Not-thermoform |
| 4 | 6 mm | 95.0 | 102.4 | Thermoform |
| 5 | 6 mm | 97.9 | 103.2 | Not-thermoform |
| 6 | 6 mm | 90.7 | 94.9 | Thermoform |
| 7 | 6 mm | 93.1 | 101.1 | Thermoform |

TABLE 3
Screwing Results

| Example | Thickness | Screwing |
|---|---|---|
| 1 | 12 mm | Fracture |
| 2 | 12 mm | Without fracture |
| 3 | 12 mm | Without fracture |
| 1 | 3 mm | Fracture |
| 4 | 3 mm | Without fracture |
| 5 | 3 mm | Fracture |
| 6 | 3 mm | Without fracture |
| 7 | 3 mm | Without fracture |

TABLE 4
Flexing mechanical properties results

| | | Maximum | Fracture | Flexing | |
|---|---|---|---|---|---|
| | | stress | elongation | modulus | Work |
| Example | Thickness | (MPa) | (%) | (MPa) | (Nmm) |
| 1 | 3 mm | 38.31 | 1.01 | 5613.30 | 54.42 |
| 4 | 3 mm | 36.47 | 1.14 | 4986.63 | 65.93 |
| 5 | 3 mm | 56.19 | 2.23 | 3009.70 | 158.37 |
| 6 | 3 mm | 36.27 | 7.70 | 1384.33 | 496.90 |
| 7 | 3 mm | 58.40 | 2.93 | 2917.45 | 266.32 |

Table 1 shows the results from the impact tests of the different polymeric mixtures. The impact strength value in which the material is completely broken is reported. The Gardner impact strength of the polymeric mixture with 70% of alumina and variable amounts of elastomer and styrene (tests 1, 2 and 3) was considerably increased with the elastomer content (6-8%). A conventional material as is indicated in the prior art depicted in Example 1, in which the elastomer was not added, shows low levels of break strength (8.13 N·m). Conversely, in Example 2 for 6% elastomer additions and 20% styrene, the material increases its impact strength up to energy levels of 30.73 N·m. Furthermore, Example 3 shows that for elastomer additions at levels of 8% and styrene at 20%, the material does not break at lesser energy levels of 36.16 N·m. The impact strength increase of the material was also observed in mixture with lesser elastomer content (4%) and styrene (15%), as is indicated in Example 4. This strength increase was corroborated in materials with 12 mm thickness (Gardner) and 3 mm (Dynatup and Izod) as shown in the results of Table 1. The higher impact strength of the composite materials with high levels (70%) of mineral charge (ATH) may confer to material, the ability to carry out drilling and screwing operations.

The impact strength determination was made for polymeric mixtures with lesser mineral charge content (40%). In Examples 5, 6 and 7 which lesser alumina levels (22%) and granite additions were used (18%), the impact strength also was increased with the presence of the elastomer and styrene. It is important to observe that, when the alumina content was diminished, the materials showed considerable impact strength, although lesser than the previous case (70%). Because of presence of the elastomer and the styrene comonomer, the impact strength were enhanced considerably. As may be observed from Examples 6 and 7, the tensile strength enhancement is not proportional to the amount of added elastomer. That is to say, the material with 3% elastomer and 10% styrene (Example 7) shows impact values very similar to Example 6, which only contains 6% elastomer. Therefore, it is observed that the comonomer gives a benefit to the impact strength by enhancing the elastomer grafting. This behavior of tensile strength increase of the material was observed in samples of 3 mm (Dynatup and Izod) and 6 mm (Gardner).

The materials from Examples 1, 4, 5, 6, 7 were subject to a thermoforming process, wherein the materials are heated and then thermoformed in accordance with the previously described methods. In this case, the results reported in Table 2 indicate whether the material could be thermoformed. For the material without an elastomer content of Examples 1 and 5 it was not possible to attain the piece thermoforming, because the materials were broken when subjected to the process, even though Example 5 contains low charge levels (40%). The deflection temperature results (HDT) from Table 2 support this behavior, inasmuch as the resultant materials from the Examples (1 and 5) show the higher temperatures in order to attain the thermoforming given as results of HDT 99.0° C. and 97.9° C., respectively. In regard to the materials with an elastomer and comonomer additions from Examples 4, 6 and 7, the piece is transformed. Notwithstanding, the material (Example 4) with high alumina content (70%) shows a deficient superficial quality. In regard to Examples 6 and 7 the material is transformed with good superficial quality at lesser levels of mineral charge (40%). This behavior is consistent with HDT results inasmuch as Example 4 shows a higher value of HDT (95° C.) compared with Examples 6 and 7 which show values HDT of 90.7° C. and 93.1° C., respectively. The lesser values of HDT indicate the possibility of best thermoforming.

In accordance with the screwing results (Table 3), the Examples 1 and 5 show fracture during the operation. This observation is consistent with the lesser impact strength and the higher thermoforming temperature determined for this materials, compared with Examples 4, 6 and 7. This tendency in material properties from Examples 6 and 7, that is the increased in impact strength, the lesser temperature thermoforming and fracture absence in screwing, is consistent with the determined parameters of flexing strength (Table 4). The materials show a considerable fracture percent elongation (Example 6—7.7% and Example 7—2.93%), as well as good flexing strength (Example 6—36.27 MPa and Example 7—58.4 MPa), in addition to a moderate mechanical stiffness (modulus) (Example 6—1384.33 MPa and Example 7—2917.45 MPa) The results indicate that the materials from Examples 6 and 7 show the higher ability to absorb energy in mechanical work form (Example 6—497 Nmm and Example 7—266 Nmm), compared with Examples 1, 4, 5 wherein the tensile strength is between 54 and 158 Nmm. The materials that show best strength and formability properties are those that contain a mineral charge of 40% and moderate amount of elastomer and styrene.

While various aspects of the invention are disclosed herein, it will be understood that various changes and modifications can be made without departing from the scope of the invention as defined in the following claims.

What is claimed is:

1. An acrylic molding composition for forming a molded matrix, the composition comprising:
a prepolymer formed from an alkyl acrylate or alkyl methacrylate monomer and a polymeric elastomer dispersed in the monomer, wherein the prepolymer has a conversion ratio of 1% to 30%; and
an inorganic particulate mineral material, wherein the elastomer is included in an amount to provide a predetermined mechanical, thermal and processing property.

2. The acrylic composition of claim 1, wherein the composition comprises about 20 to 95 parts by weight of the prepolymer, about 0 to 50 parts by weight of an ethylenically unsaturated monomer, 0.1 to 10 parts by weight of the polymeric elastomer, and 5 to 80 parts by weight of the inorganic particulate material.

3. The acrylic composition of claim 2, wherein the ethylenically unsaturated monomer is styrene and is included in an amount of 1 to 50 parts by weight, the allyl acrylate or alkyl methacrylate is included in an amount of 100 to 50 parts by weight, and the elastomer is included in an amount of 0.1 to 10 parts by weight.

4. The acrylic composition of claim 1, further comprising an ultraviolet light stabilizer agent in an amount of 0.05 to 0.5 parts by weight, an initiator in an amount of 0.01 to 1 parts by weight, a chain transfer agent in an amount of 0.01 to 0.1 parts by weight with respect to the weight of the monomers, a dispersing agent in an amount of 0.01 to 2 parts by weight with respect to the weight of the composition, a deaerator in an amount of 0.1 to 1 part by weight with respect to the weight of the composition, a viscosity controller in an amount of 0.01 to 2 parts by weight with respect the weight of the composition, a mold release agent in an amount of 0.003 to 1 part by weight with respect to the weight of the composition, a thermal stabilizer in an amount of 0.01 to 1 part by weight with respect to the weight of the composition, a crosslinking agent in an amount of 0.0001 to 2 parts by weight with respect to the weight of the composition, and from 0 to 30 parts by weight of pigments and granites.

5. The acrylic composition of claim 4, wherein the initiator is a peroxide or azo type polymerization initiator in an amount of 0.001 to 1 parts by weight.

6. The acrylic composition of claim 1, wherein the ethylenically unsaturated monomers are selected from the group consisting of styrene, butyl acrylate, methyl acrylate and ethyl acrylate.

7. The acrylic composition of claim 1, wherein the elastomer is a polymer obtained from a diene monomer.

8. The acrylic composition of claim 1, wherein the elastomer is selected from a group consisting of high cis and medium cis polybutadiene, acrylonitrile-butadiene-styrene (ABS), copolymers of styrene-butadiene-styrene-(SBS), styrene-butadiene (SB), functionalized polybutadiene and mixtures thereof.

9. The acrylic composition of claim 1, wherein the composition includes an ultraviolet light stabilizer agent of the HALS type stabilizers (Hindered Amine Light Stabilizers) selected from group consisting of bis-(1-octyloxy-2,2,6,6,tetramethyl-4-piperidinil)sebacate; dimethyl succinate polymer with 4-hydroxy-2,2,6,6,tetramethyl-1-piperidin ethanol; bis(2,2,6,6,-tetramethyl-4-piperidinyl)sebacate; 1,3,5-triazin-2,4,6-triamino, N,N″-[1,2-ethanodiylbis[[[4,6-bis[butyl(1,2,2,6,6-pentamethyl-4-piperidinyl)amino]-1,3,5-triazin-2-yl]imino]-3,1propanediyl]]-bis[N,N″-dibutyl-N,N″-bis(1,2,2,6,6-pentamethyl-4-piperidinil)-; poly-[[6-[(1,3,3,-tetramethyl butyl)amino]-s-triazine-2,4-diyl][[(2,2,6,6-tetramethyl-4-piperidyl)imino]hexamethylene[(2,2,6,6-tetramethyl-4-piperidyl)imino]]; 2-(2′,hydroxy-5-methyl-phenyl)benzotriazole; 2-(2H-benzotriazole-2-ii)-4,6-bis(1-methyl-1-phenylethyl)phenol; 2-(5-chloro-2H-benzotriazole-2-yl)6-(1,1-dimethylethyl)-4-methylphenol; 2-(3′,5′-di-tert-butyl-2-hydroxyphenyl)-5-chlorobenzotriazole; 2-(2H-benzotriazole-2-yl)-4,6-bis(1,1-dimethylpropyl)phenol, or mixtures of the same.

10. The acrylic composition of claim 1, wherein the composition includes an initiator of the peroxide type or azo type selected from group consisting of terbutyl peroxypivalate, terbutyl peroxyneodecanoate, azo-bis-iso buthyronitrile, 2,2′-azobis(2,4-dimethylpentanonitrile), bi(4-terbutylcyclohexyl)peroxydicarbonate and tert-butyl monoperoxymaleate.

11. The acrylic composition of claim 1, wherein the composition includes a chain transfer agent selected from the group consisting of n-dodecyl mercaptan, n-octyl mercaptan and n-butyl mercaptan.

12. The acrylic composition of claim 1, wherein the mineral is selected from group consisting of calcium carbonate, silica, glass spheres, mica spheres, alumina, and trihydrated alumina (THA).

13. The acrylic composition of claim 4, wherein the dispersing agent is selected from the group consisting of ester solutions from hydroxyfunctional carboxylic acid, esters from hydroxyfunctional carboxylic acid, copolymers with acid groups, amide solutions from polyhydroxycarboxylic acid, salt solution from unsaturated polyamineamides, low molecular weight acidic polyesters, salt solutions from polycarboxylic acid from polyamides, polymer solution from low molecular weight unsaturated polycarboxylic acid, polymers from unsaturated polycarboxylic acid, and esters from polar acid from long chain alcohols.

14. The acrylic composition of claim 4, wherein the deaerator is selected from the group consisting of the dissolution of polymers and foam destroyer polysiloxanes, polymeric anti-foaming without silicone, polyacrylate dissolution and foam destroyer polymers without silicone.

15. The acrylic composition of claim 4, wherein the viscosity regulator agent is a dissolution of a modified urea type.

16. The acrylic composition of claim 4, wherein the mold release agent is a sodium dioctylsulfosuccinate surfactant or a solution from phosphated alcohol non-neutralized anionic type surfactant.

17. The acrylic composition of claim 4, wherein the thermal stabilizer is a phosphite type selected from the group consisting of di-phenyl isodecyl phosphite, trinonyl phenyl phosphite, diisodecyl phenyl phosphite, triisodecyl phosphite and a compound of the formula P0₃-R₁R₂R₃, wherein R₁R₂R₃ are substituents hydrocarbon type with 2 to 30 carbon atoms.

18. The acrylic composition of claim 4, wherein the crosslinking agent is selected from the group consisting of ethylene glycol dimethacrylate, diethyleneglycol dimethacrylate, triethyleneglycol dimethacrylate, tetraethyleneglycol dimethacrylate, tetradecapropyleneglycol dimethacrylate and neopentyl glycol diacrylate.

19. The acrylic composition of claim 4, wherein the pigments and granites are included in an amount of 0 to 30 parts by weight, wherein the granites are materials made based on alumina, titanium dioxide and where the pigments are polyester grains, acrylic grains or minerals.

20. A process for producing moldable acrylic composite materials with mineral charges, with superior mechanical, thermal and processing properties, for furniture manufacturing, comprising the following steps:
Step 1, preparing a prepolymer or resin preparation by mixing and reacting a polymerizable monomer in the presence of one or more polymeric elastomers, wherein the elastomer is dispersed in the monomer component;
Step 2, dispersing a mineral component into the prepolymer;
Step 3, filling a mold with the prepolymer and mineral dispersion and polymerizing and curing the dispersion and heating to a temperature to achieve a 95% monomer conversion; and
Step 4, thermal treatment or post-curing to attain the total monomer conversion, cooling the mold and separating the final product from the mold.

21. The process of claim 20, wherein the prepolymer or resin preparation is prepared by constant agitation in a reservoir of the monomers and elastomers, wherein the prepolymer includes an ethylenically unsaturated monomer in an amount of 0 to 50 parts by weight and from 100 to 50 parts of alkyl acrylates or alkyl methacrylates.

22. The process of claim 20, wherein the prepolymer includes the elastomer in an amount of 0.1 to 10 parts by weight, and the elastomer is a polymer from a diene monomer dissolved and integrated into the monomer component.

23. The process of claim 22, wherein the elastomer is selected from the group consisting of polybutadiene (PB) from high cis or medium cis types, acrylonitrile-butadiene-styrene (ABS), copolymers of styrene-butadiene-styrene (SBS), styrene-butadiene (SB), functionalized polybutadiene, and mixtures thereof.

24. The process of claim 20, wherein the prepolymer includes HALS type (Hindered Amine Light Stabilizers) UV stabilizer selected from the group consisting of bis-(1-octyloxy-2,2,6,6,tetramethyl-4-piperidinil)sebacate; dimethyl succinate polymer with 4-hydroxy-2,2,6,6,tetramethyl-1-piperidin ethanol; bis(2,2,6,6,-tetramethyl-4-piperidinyl)sebacate; 1,3,5-triazine-2,4,6-triamino, N,N″-[1,2-ethanodiylbis[[[4,6-bis[butyl(1,2,2,6,6-pentamethyl-4-piperidinyl)amino]-1,3,5-triazine-2-yl]imino]-3,1propanediyl]]-bis[N,N″-dibutyl-N,N″-bis(1,2,2,6,6-pentamethyl-4-piperidinil)-; poly-[[6-[(1,3,3,-tetramethyl butyl)amino]-s-triazine-2,4-diyl][[(2,2,6,6-tetramethyl-4-piperidyl)imino]hexamethylene[(2,2,6,6-tetramethyl-4-piperidyl)imino]]; or mixtures thereof, wherein the ultraviolet light stabilizer agents are selected from the group consisting of 2-(2′,hydroxy-5-methyl-phenyl)benzotriazole; 2-(2H-benzotriazole-2-ii)-4,6-bis(1-methyl-1-phenylethyl)phenol; 2-(5-chloro-2H-benzotriazole-2-yl)6-(1,1-dimethylethyl)-4-methylphenol; 2-(3′,5′-di-tert-butyl-2-hydroxyphenyl)-5-chlorobenzotriazole; 2-(2H-benzotriazole-2-yl)-4,6-bis(1,1-dimethylpropyl)phenol, or mixtures thereof, wherein the ultraviolet light stabilizer agent mixture is selected from the group consisting of 2-(2hydroxy-5-methyl-phenyl)benzotriazole and bis-(2,2,6,6-tetramethyl-4-piperidinyl)sebacate.

25. The process of claim 20, wherein the prepolymer is produced by heating to a temperature of 20° C. to 90° C., and where a peroxide type or azo type initiator in amounts of 0.01 to 1 parts by weight and selected from the group consisting of terbutyl peroxypivalate, terbutyl peroxyneodecanoate, azo-bis-iso buthyronitrile, 2,2′-azobis(2,4-dimethylpentanonitrile), bi(4-terbutylcyclohexyl)peroxydicarbonate or tert-butyl monoperoxymaleate, the prepolymer further including a chain transfer agent in amounts of about 0.01 to 0.1 parts by weight; wherein the chain transfer agent is a mercaptan selected from group consisting of n-dodecyl mercaptan, n-octyl mercaptan or n-butyl mercaptan.

26. The process of claim 20, wherein the prepolymer has a 1 to 30% monomer conversion to form elastomeric particles having a particle size of 0.1 to 50 microns in the monomer component and wherein the prepolymer is cooled to produce a mean molecular weight of 100,000 to 1,000,000 Daltons and polydispersivities of 2 to 3.

27. The process of claim 20, wherein 20 to 95 parts by weight of the prepolymer is mixed with the mineral under a vacuum, wherein the mineral is selected from group consisting of calcium carbonate, silica, glass spheres, mica spheres, alumina, and trihydrated alumina (ATH), in an amount of 5 to 80 parts by weight.

28. The process of claim 20, wherein the composition further includes 0.01 to 2 parts by weight of a dispersing agent selected from the group consisting of an ester solution from hydroxyfunctional carboxylic acid, ester from hydroxyfunctional carboxylic acid, copolymer with acid groups, amides solution from polyhydroxycarboxylic acid, salt solution from unsaturated polyamineamides and low molecular weight acidic polyester, salt solution from polycarboxylic acid from polyamides, polymer solution from low molecular weight unsaturated polycarboxylic acid, low molecular weight unsaturated polycarboxylic acid polymer, and polar acid ester from long chain alcohols, the composition further including 0.1 to 1 part by weight with respect to the mixture of a deaerator agent selected from the group consisting of polymer dissolution and foam destroyer polysiloxanes, polymeric anti-foaming without silicone, polyacrylate dissolution and foam destroyer polymers, without silicone, foam destroyer polymer dissolution, without silicone, and from 0.01 to 2 parts by weight of a viscosity regulator agent of the modified urea dissolution type.

29. The process of claim 20, wherein the composition comprises a mold release agent, a sodium dioctylsulfosuccinate type surfactant and an anionic type non neutralized phosphated alcohol solution in amounts of 0.003 to 1 parts by weight with respect to the mixture, a thermal stabilizer in amounts of 0.01 to 1 parts by weight with respect to the mixture of the phosphite type which is selected from the group consisting of di-phenyl isodecyl phosphite, trinonyl phenyl phosphite, di-isodecyl phenyl phosphite, triisodecyl phosphite or any compound from formula P0₃-R₁R₂R₃, wherein R₁R₂R₃ are substituents hydrocarbon type with 2 to 30 carbon atoms, a crosslinking agent selected from the group consisting of ethylene glycol dimethacrylate, diethyleneglycol dimethacrylate, triethyleneglycol dimethacrylate, tetraethyleneglycol dimethacrylate, tetradecapropyleneglycol dimethacrylate, neopentyl glycol diacrylate in amounts of 0.001 to 2.0 parts by weight with respect to the composition.

30. The process of claim 20, wherein the mineral is trihydrated alumina, and the composition further comprises pigments and granites in an amount of 0 to 30 parts by weight, wherein the granites are materials based on alumina, titanium dioxide, polyester grains, acrylic grains, or minerals.

31. The process of claim 20, wherein the peroxide type or azo type initiating agent is selected from the group consisting of terbutyl peroxypivalate, terbutyl peroxyneodecanoate, azo-bis-iso butyronitrile, 2,2′-azobis(2,4-dimethylpentanonitrile, bis(4-terbutylcyclohexyl)peroxydicarbonate and tert-butyl monoperoxymaleate, in amounts of 0.001 to 1 part by weight with respect to the composition, and where the polymerization is carried out at a pressure of 30 and 60 cm Hg.

32. The process of claim 20, wherein in the polymerization is carried out at room temperature up to 80° C. to allow the polymerization initiation to reach a monomer conversion of 95% during a period of 3 to 5 hours.

33. The process of claim 20, wherein the thermal treatment comprises subjecting the mold to a thermal treatment at temperature of 90° C. to 130° C. in order to attain the total monomer conversion (˜100%) during a period of 1 to 5 hours.

34. The process of claim 20, wherein the final product is a composite having a multi-phase structure with the elastomer particles dispersed in the polymeric phase, wherein the elastomer is segregated in cellular particle form, layered or core-shell, the continuous polymer phase encircles the elastomer particles and the mineral particles.

35. An acrylic composite material with mineral charges, with superior mechanical, thermal and processing properties, characterized by possessing high impact strength Gardner (ASTM D-3029) from 6.33 to 36.16 N.m, in thicknesses of 12 mm, with ability to withstand heating temperatures up to 200° C. without thermal degradation.

36. The acrylic composite materials of claim 35, possessing a fracture percent elongation higher than 7.7% and up to 23%, a bending strength higher than 3.45E+04 kPa and up to 5.84E+04 kPa, a mechanical rigidity (modulus) of 1.38E06 kPa up to 2.92E+06 kPa, and a capacity to absorb energy in mechanical work form of 266 Nmm to 497 Nmm.

37. The acrylic composite materials of claim 35, wherein the final product is in the form of plates thermoformed in a single piece by heating of the plate up to about 200° C. and then by in vacuo thermoforming, pressure or by elastic membrane action over molds, and cooling to adopt the desired shape.

38. The acrylic composite materials of claim 35, wherein the final product has a high breaking strength when subject to drilling stresses by screwing for assembly of furniture, doors, or hatchways, without suffering chipping or fracture.
